(19) United States
(12) Patent Application Publication
(10) Pub. No.: US 2006/0022452 A1
(43) Pub. Date: Feb. 2, 2006

(54) Credit card protector with account log

(76) Inventor: Scott B. Lewis, Long Beach, CA (US)

Correspondence Address: Marshall A. Lerner;KLEINBERG & LERNER, LLP, Suite 1080, 2049 Century Park East, Los Angeles, CA, 90067, US

(21) Appl. No.: 10/901,764

(22) Filed: Jul. 29, 2004

(51) Int. Cl. B42D 15/00

(52) U.S. Cl. 283/66.1

(57) ABSTRACT

A credit card protector with account log includes an envelope of sheet material forming a sleeve for protecting a credit or debit card. A pre-printed grid defines a writing area on a surface of the envelope. A user writes transaction information on the envelope when using the card. The envelope may receive the card from the top, side, or corner. The envelope may be partially or completely transparent or translucent. Grid lines or graphics may be printed on an interior or exterior surface of the envelope and visible through a translucent portion thereof. The envelope may be partly or completely formed of a stiffened or reinforced material such as cardboard. The envelope may be partly or completely formed of a print-retaining material. The envelope may be partly or completely formed of an ink-retaining or graphite-retaining material.

### BACKGROUND OF THE INVENTION

The present invention relates to envelopes and sleeves, also to pre-printed forms and handwritten logs, and more particularly to pre-printed protective envelopes and sleeves for use with a credit card or debit card.

### FIELD OF THE INVENTION

In today's changing banking and purchasing society, the use of, and change over to, credit cards, ATM cards, transaction cards, debit cards, and gift cards, it is much more difficult to manage account balances and transaction records. Many individuals do not carry account registers for checkbooks due to size and convenience limitations. When using a transaction card, most people save the receipt and record the purchase or use when they get home or to wherever their account register is stored. Many lose the receipt, or forget to enter the transaction. Cards are often damaged due to storage or exposure. It would be helpful to have a means of protecting and storing a credit card or any other transaction account card from damage. It would also be helpful to have a simple, manual way of logging transactions and uses of the card.

### SUMMARY OF THE INVENTION

The present invention protects credit cards and provides a convenient means of manually logging transactions. An exemplary embodiment of a credit card protector with account log in accordance with the present invention includes an envelope having two ends, two edges, a front side and a back side. The envelope is configured to receive and retain a transaction card. A surface of the envelope bears indicia defining a series of areas for writing. A surface of the envelope is capable of retaining written inscription.

In an exemplary embodiment of the present invention, the envelope is open at one end.

In an exemplary embodiment of the present invention, the envelope is open at one edge.

In an exemplary embodiment of the present invention, at least a portion of the front side of the envelope is of greater stiffness than the rear side.

In an exemplary embodiment of the present invention, at least a substantial central portion the front side of the envelope is translucent.

In an exemplary embodiment of the present invention, the interior of the back surface of the envelope bears the indicia defining a series of areas for writing.

An envelope about the size of a credit card is provided for easy storage within any wallet or purse where a credit card is commonly stored. The envelope is made of a durable material which can be pre-printed with text and graphics and which can be written on. A register log is printed upon both sides of the envelope for keeping records of card use. The log includes printed columns in which the user writes the date, purchase type, amount, and balance, or other desired information. The log is later stored for account balancing and record keeping.

The envelope may be provided as a blank register. Brand names may be printed on it for easy identification with a card. The envelope may be marketed in packs of ten, and may be private-labeled for banks and other card issuers. A consumer may order the envelope by mail preprinted with desired information. A consumer will easily adopt the present invention. The typical consumer is already in the habit of pulling a transaction card out of a wallet and using it to make a transaction. With the present invention, the consumer will pull out the credit card protector with account log in the process of pulling out the card. The consumer is already accustomed to signing for the transaction. Now, having pen in hand, the consumer will be ready to record important information about the transaction on the credit card protector and account log.

### BRIEF DESCRIPTION OF THE DRAWING

For a further understanding of the objects and advantages of the present invention, reference should be had to the following detailed description, taken in conjunction with the accompanying drawing, in which like parts are given like reference numbers and wherein:

FIG. 1 is a plan view of a credit card protector with account log in accordance with the present invention in a cut-open configuration; and

FIG. 2 is a plan view thereof in a finished configuration with a transaction card inserted.

### DESCRIPTION OF PREFERRED EMBODIMENTS

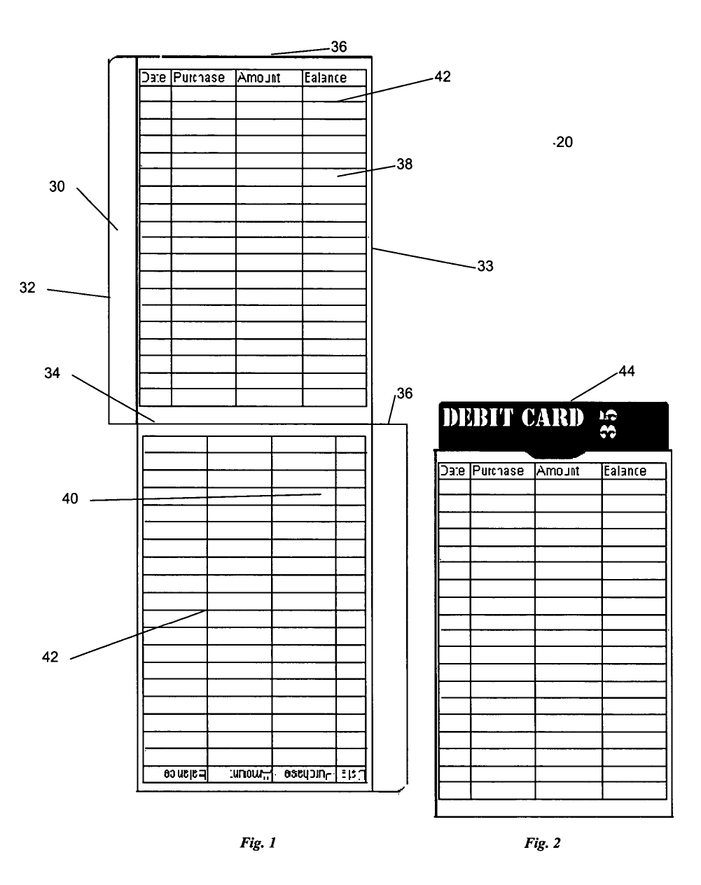

FIG. 1 shows a top plan view of a credit card protector with account log in accordance with the present invention, shown generally at 20, comprising a substantially rectangular envelope 30 having folded left edge 32, folded right edge 33, folded bottom 34, an open top 36, a front side 38, and a rear side 40. For illustrative convenience, the envelope 30 is shown in FIG. 1 with the left edge 32 and the right edge 34 cut open and the rear side 40 unfolded and hanging downward (note the inverted text).

With continued reference to FIG. 1 and also to FIG. 2, the envelope 30 is made in a size sufficient to accept and hold a standard credit card or bank card 44 measuring 85 mm by 54 mm. Accordingly, the envelope 30 measures approximately 88 mm from top 36 to bottom 34 by 57 mm from the left edge 32 to right edge 33. To protect the enclosed card, the envelope 30 is formed with a non-abrasive and non-adhesive interior. To avoid damaging other items stored in contact with the exterior of the envelope 30 and to facilitate repeated removal and reinsertion of the card in a wallet, the envelope 30 is formed with a non-abrasive and non-adhesive exterior surface.

A tabular grid 42 is printed on the front side 38 and on the rear side 40. The grid 42 comprises columns whose first entries are shown bearing the pre-printed labels “Date,” “Purchase,” “Amount,” and “Balance.” Each column comprises a plurality of rows. The front side 38 and the rear side 40 possess surface characteristics suitable both for retaining these pre-printed lines and for retaining ink and graphite, so that a person with a pen or pencil may write in the spaces formed between the lines and the writing will be retained.

The envelope 30 generally is formed by cutting, folding and gluing or otherwise bonding a sheet material such as paper, cardboard, reinforced paper, or Tyvek® brand sheeting. Any durable, flexible product may be used, including, for example, Wove paper, recycled paper, plastic, or clear plastic. A printer can be used to make a run of items for a given graphic design including, for example, a trademark of a credit card company or an issuing bank.

Depending on the range of printing processes and writing implements that are to be used to make and use the credit card protector with account log in accordance with the present invention, it may be preferable to select a sheet material which accepts the intended range of inks. For example, the United States Postal Service uses large envelopes made of Tyvek® brand sheeting on which text and colorful graphics are pre-printed. This material accepts non-water-soluble ink from a ballpoint pen very well, pencil not quite as well but legibly, and some water-soluble inks rather poorly. Thus, if an envelope 30 formed of Tyvek® brand sheeting, one way of making it more compatible with the full range of writing implements is to apply a paper layer over the sheeting to form the front side 38, the rear side 40, or both. If it is desired to make the envelope 30 stiff enough that, when the front side 38 or rear side 40 is written on, the raised writing on the credit card does not interfere with the act of writing, then a thicker paper layer may be used.

In use, the credit card protector with account log in accordance with the present invention serves as a sleeve or protector for a credit card or bank card. The card is inserted into the envelope 30 and withdrawn therefrom through the open top 36. The credit card protector with account log is also used to record activity on the account when the card is used. A person using the card writes a new entry including the date in the date column, activity-identifying information in the purchase column, the amount of the activity in the amount column, and the estimated resulting account balance in the balance column.

In another exemplary embodiment of the credit card protector with account log in accordance with the present invention, the envelope 30 is folded at the top and bottom 34 and on the left edge 32, the right edge 33 being open to receive a credit card sideways instead of lengthwise.

In another exemplary embodiment of the credit card protector with account log in accordance with the present invention, the envelope 30 is folded at the bottom 34 and on the right edge 33, the top 36 and the left edge 32 being open to receive a credit card.

In another exemplary embodiment of the credit card protector with account log in accordance with the present invention, the envelope 30 is formed of a material stiff enough that, when the front side 38 or rear side 40 is written on, the raised writing on the credit card does not interfere with the act of writing.

In another exemplary embodiment of the credit card protector with account log in accordance with the present invention, the envelope 30 is formed of a translucent material such that, although the front side 38 and the rear side 40 are capable of retaining ink and graphite when written on, the writing and graphic designs of the credit card can be seen through the envelope 30. This makes it easier to confirm that the envelope 30 being written on corresponds to the card whose use is being written about.

In another exemplary embodiment of the credit card protector with account log in accordance with the present invention, the front side 38 of the envelope 30 is formed of a translucent material such that, although the front side 38 and the rear side 40 are capable of retaining ink and graphite when written on, writing and graphic designs placed behind the front surface are visible through the front surface. The interior of the back surface is pre-printed with the above-described tabular grid 42. While the credit card is still removed from the envelope 30, the grid 42 is visible through the front side 38 of the envelope 30. Transaction information may be written on the front side 38 of the envelope 30, using the grid 42 as a guide for writing in discretely arranged rows and columns. A person might find this format helpful if, for example, the writing is later to be scanned by a character-recognizing computer in the absence of confusing grid lines. Additionally, if it is necessary to remove the credit card 44 from the envelope 30 in order to see the grid 42 while writing on the front side 38 of the envelope 30, an opportunity is afforded to verify that the credit card 44 withdrawn from the envelope 30 is the one the information being written pertains to.

While the foregoing detailed description has described several embodiments of a credit card protector with account log in accordance with the present invention, it is to be understood that the above description is illustrative only and not limiting of the disclosed invention. Indeed, it will be appreciated that the embodiments discussed above and the virtually infinite embodiments that are not mentioned could easily be within the scope and spirit of the present invention. Thus, the present invention is to be limited only by the claims as set forth below.

What is claimed is:

1. A credit card protector and account log, comprising:
an envelope having two ends, two edges, a front side and a back side;
said envelope being configured to receive and retain a transaction card;
a surface of said envelope bearing indicia defining a series of areas for writing, and
a surface of said envelope being capable of retaining written inscription.

2. A credit card protector with account log as set forth in claim 1, wherein said envelope is open at one end.

3. A credit card protector with account log as set forth in claim 1, wherein said envelope is open at one edge.

4. A credit card protector with account log as set forth in claim 1, wherein at least a portion of said front side of said envelope is of greater stiffness than said rear side.

5. A credit card protector with account log as set forth in claim 1, wherein at least a substantial central portion said front side of said envelope is translucent.

6. A credit card protector with account log as set forth in claim 5, wherein the interior of said back surface of said envelope bears said indicia defining a series of areas for writing.
